(19) United States
(12) Patent Application Publication
(10) Pub. No.: US 2026/0170558 A1
(43) Pub. Date: Jun. 18, 2026

(54) SYSTEMS AND METHODS FOR HYBRID BLOCKCHAIN AND OFF-CHAIN ASSET TRACKING

(71) Applicant: FMR LLC, Boston, MA (US)

(72) Inventors: Sterling Ingui, Durham, NC (US); David Gray, West Palm Beach, FL (US); Carl Rehbein, Marlborough, MA (US); Raghavendra Setty, Bengaluru (IN); Pritam Nikam, Bangalore (IN); Palani Vel Rajan Ravindran, New Hill, NC (US); Patrick Flanagan, Canton, MA (US)

(21) Appl. No.: 18/982,785

(22) Filed: Dec. 16, 2024

(51) Int. Cl. G06Q 40/06; G06Q 10/1057; G06Q 20/36; G06Q 20/38

(52) U.S. Cl. CPC G06Q 40/06; G06Q 10/1057; G06Q 20/3672; G06Q 20/389

(57) ABSTRACT

A computer-implemented method is provided for maintaining multiple retirement plans for a user using a combination of a blockchain account and an off-chain account associated with the user. The method includes creating and maintaining the blockchain account for the user that comprises one or more digital wallets corresponding to one or more retirement account types of the retirement plans and a smart contract configured to manage the one or more digital wallets. The method also includes receiving, via the off-chain account of the user, a transaction request with respect to a target retirement plan and processing, by the smart contract of the blockchain account of the user, the transaction request. The method further includes storing, on chain, a proof of execution of the transaction request including a cryptographic proof of off-chain data related to the execution of the transaction request stored in the off-chain account of the user.

### BACKGROUND

### Technical Field

This application generally relates to systems, methods and apparatuses, including computer program products, for maintaining and tracking financial assets for a user using a combination of blockchain (i.e., on-chain) and off-chain accounts.

### Background Information

Individuals change jobs on average twelve times in their working careers. Traditional retirement plan recordkeeping platforms are managed at the employer level and often have unique plan rules per employer and plan type. As employees switch employment or work for multiple employers, discrete accounts need to be established for each new working relationship on different recordkeeper's platforms. Employees must then maintain investments across multiple accounts with multiple recordkeepers or take cumbersome steps to consolidate assets where allowed. Disparate systems can lead to inconsistent views of data and plan rules, making it challenging for a participant to have a clear view of one's overall retirement savings and the corresponding plan rules that can have restrictions or fees when action is taken. Therefore, traditional systems are disparate and disconnected, which makes critical data sharing and asset transfer difficult.

There is a need for a consolidated platform that enables individuals to manage their retirement savings across multiple employers.

### SUMMARY

The present invention features a standalone blockchain recordkeeping platform implementation, within which individuals can hold assets in a single account even though they may have or may have had multiple employers and recordkeepers. By creating a method that can be fully on-chain or a hybrid platform, individuals can have multiple accounts both on chain and off-chain. For example, existing off-chain technology platforms with employer plan-specific rules can be tied to an on-chain account that represents a participant's broader activity in a consolidated view for managing his/her overall retirement savings across employers and recordkeepers.

In the present invention, blockchain and smart contracts allow multiple parties to deploy and execute heterogenous code on a common platform in a trusted manner. In general, blockchain is a decentralized digital ledger that securely stores records across a network of computers also known as “nodes” in a way that is transparent, immutable, and resistant to tampering. Each “block” contains data, and blocks are linked in a chronological “chain.” Data integrity is preserved and security is enabled via cryptographic hashing and consensus mechanisms. A smart contract is a self-executing program where the terms of the agreement or conditions are directly written into lines of code. These contracts are stored and replicated on a blockchain network and automatically execute actions when predetermined conditions are met. Blockchain technology and smart contracts in combination mitigate the risks and burdens of existing platforms, systems and processes by providing more security, efficiency, and transparency into the processing for recordkeepers and a more consolidated way for individuals to manage their retirement savings.

The present invention provides decentralized recordkeeping capabilities supported by a fully on-chain recordkeeping platform or a hybrid system of on-chain and off-chain record keeping that captures transactions and holdings pertaining to an individual's financial assets, such as multiple retirement savings accounts throughout the individual's employment across multiple employers and/or recordkeepers. The on-chain data enables clarity of account ownership and activities across the individual's assets. In some embodiments, the on-chain data is persistent regardless of market values and fluctuations. In some embodiments, on-chain data is appended with clear proof-of-ownership. The off-chain data can include any transient data and corresponding logic required to calculate transactions or holdings. The off-chain data can also include personally identifiable information (PII) in its original form. In a synchronized manner, the on-chain data can store data anchors of transaction data and metadata that are in the off-chain persistent storage. Synchronization of the on-chain and off-chain data as a single source of truth in association with the individual user can be accomplished via context stitching based on unique identifiers. In general, this hybrid platform represents a decoupled architecture that enables pluggability and flexibility while providing data security, data trackability and data storage efficiency. In some embodiments, this hybrid system is particularly well suited for use-cases involving sensitive financial and PII data, as well as high transaction volumes. Having a common platform enables recordkeeping systems to be connected via the blockchain to transfer assets transparently and near-real-time on-chain for off-chain accounts and connected systems. Furthermore, having an on-chain platform that can support hybrid platforms and digital capabilities simplifies the experience for individuals to manage disparate data and different plan rules as a worker saving for retirement.

In one aspect, the present invention features a computerized method for maintaining a plurality of retirement plans for a user using a combination of a blockchain account and an off-chain account associated with the user. The plurality of retirement plans are sponsored by a plurality of employers of the user and associated with corresponding plan rules. The method includes creating and maintaining the blockchain account for the user. The blockchain account includes: (i) one or more digital wallets corresponding to one or more retirement account types of the retirement plans sponsored by the employers, each digital wallet storing current election of one or more funds along with one or more crypto tokens representative of fiat money, shares of the one or more funds and individual and employer contributions; and (ii) a smart contract configured to manage the one or more digital wallets, the corresponding plan rules and the individual and employer contributions. The method includes receiving, via a digital user interface associated with the off-chain account of the user, a transaction request with respect to a target retirement plan from the plurality of retirement plans. The method also includes processing, by the smart contract of the blockchain account of the user, the transaction request including ensuring compliance of the transaction request with the plan rules associated with the target retirement plan, minting or burning at least one of a cash token, a fund token, a stablecoin or a tokenized digital asset class in relation to the one or more crypto tokens in the digital wallet associated with the target retirement plan to execute the transaction request without requiring a bank for fiat money transfer, updating the digital wallet associated with the target retirement plan to reflect a balance in the digital wallet after execution of the transaction request, and emitting a notification event to the corresponding off-chain account to synchronize with the blockchain account by honoring the transaction request. The method further includes storing, on chain, a proof of execution of the transaction request including a cryptographic proof of off-chain data related to the execution of the transaction request stored in the off-chain account of the user.

In another aspect, the present invention features a computer-implemented system for maintaining a plurality of retirement plans for a user using a combination of a blockchain account and an off-chain account associated with the user. The plurality of retirement plans are sponsored by a plurality of employers of the user on a plurality of recordkeeping platforms. The computer-implemented system comprises a computing device having a memory for storing instructions. The instructions, when executed, configured to computer-implemented system to provide at least a wallet module, a request module and a processing module. The wallet module is configured to manage a plurality of digital wallets stored in a blockchain under the blockchain account of the user. The plurality of digital wallets corresponds to different retirement account types of the retirement plans sponsored by the employers. Each digital wallet is configured to (i) store current election of one or more funds along with one or more crypto tokens representative of fiat money and shares of the one or more funds and (ii) track individual and employer contributions. The request module is configured to receive a transaction request with respect to a target retirement plan from the plurality of retirement plans of the user. The processing module is configured to process the transaction request. In particular, the processing module is configured to ensure compliance of the transaction request with one or more rules associated with the target retirement plan, interact with a transaction module to mint or burn at least one of a cash token or a fund token in relation to the one or more crypto tokens in the digital wallet associated with the target retirement plan to execute the transaction request, update the digital wallet associated with the target retirement plan to reflect a balance in the digital wallet after execution of the transaction request, and interact with an event listener module to emit a notification event to the corresponding off-chain account to synchronize with the blockchain account by honoring the transaction request. In addition, the transaction module is further configured to (i) generate a proof of execution of the transaction request including a cryptographic proof of off-chain data related to the execution of the transaction request stored in the off-chain account of the user; and (ii) store the proof of execution on the blockchain. In some embodiments, the system further includes a transaction exploration module configured to generate a report of transaction history associated with the user, including information about one or more desired transactions related to the plurality of retirement plans.

Any of the above aspects can include one or more of the following features. In some embodiments, the blockchain account of the user further includes an on-chain identification of the user cryptographically calculated to represent the user's personal information stored in the corresponding off-chain account. In some embodiments, the blockchain account of the user includes a non-fungible token (NFT) uniquely identifies the user, guarantees on-chain ownership and connects associated data and metadata of the plurality of retirement accounts, including retirement account data in the user's off-chain account.

In some embodiments, the different retirement account types comprise different types of 401(k) plans. In some embodiments, the transaction request comprises one of contribution, withdrawal, exchange dividend allocation or rollover with respect to the target retirement plan.

In some embodiments, the at least one cash token is representative of one or more of fiat currency and stablecoins held within a digital wallet of the user, and wherein the at least one cash token is fungible. In some embodiments, the at least one fund token is representative of one or more of shares in a fund and tokenized asset classes held within a digital wallet of the user, and the at least one fund token is semi-fungible in that fund tokens of the same fund are fungible and fund tokens of different funds are non-fungible. In some embodiments, minting at least one of a cash token or a fund token comprises adding a new token to the blockchain account, and burning at least one of a cash token or a fund token comprises removing an existing token from the blockchain.

In some embodiments, the transaction request includes a contribution request to the target retirement plan. Processing the contribution request by the smart contract includes determining an amount of fiat currency for contribution to the target retirement plan, minting an equivalent amount of crypto assets comprising at least one of cash tokens, stablecoins or tokenized digital assets for addition to the digital wallet associated with the target retirement plan, minting an equivalent amount of fund tokens for addition to the digital wallet while burning the minted crypto assets from the digital wallet, and updating the digital wallet balance to reflect the minted fund tokens from the contribution.

In some embodiments, the transaction request includes a withdrawal request from the target retirement plan. Processing the withdrawal request by the smart contract comprises either transferring an existing digital asset token or as needed burning an equivalent amount of fund tokens from the digital wallet associated with the target retirement plan, if the withdrawal request is in fiat currency, minting an equivalent amount of: (i) cash tokens for addition to the digital wallet and wire transferring an equivalent fiat amount to a bank account of the user, or (ii) stablecoins or tokenized digital assets for addition to the digital wallet without wire transferring to a bank account of the user, and updating the digital wallet balance to reflect the burnt fund tokens and minted cash tokens, stablecoins or tokenized digital assets for the withdrawal.

In some embodiments, the transaction request comprises an exchange request from an originating fund to a target fund within the target retirement plan. Processing the exchange request by the smart contract comprises burning a specific amount of fund tokens from the originating fund in the digital wallet associated with the target retirement plan, minting an equivalent amount of crypto asset comprising at least one of cash tokens, stablecoins or tokenized digital assets, minting an equivalent amount of fund tokens for addition into the target fund in the digital wallet while burning the minted crypto asset, and updating the balance in the digital wallet of the user to reflect the exchange in fund tokens between the originating fund and the target fund.

In some embodiments, the transaction request is digitally signed prior to processing the transaction request by the smart contract to verify authenticity, integrity, and non-repudiation of the transaction request. In some embodiments, the proof of execution of the transaction request is also digitally signed.

In some embodiments, the proof of execution includes a transaction identifier, information about the transaction request, information about the cryptographic proof, and a timestamp of the execution of the transaction request. In some embodiments, the information about the cryptographic proof comprises a path of a cryptographic hash within a Merkle tree, including hashes of one or more sibling nodes. In some embodiments, the proof of execution on chain is stored in a separate on-chain account dedicated to storing transaction proofs.

In some embodiments, the cryptographic proof is a hashed-proof-of-commitment for recording an individual off-chain transaction. The blockchain account can maintain a commitment hash and revealed value, and the off-chain account can manage original transaction details for the hashed-proof-of-commitment scheme. In some embodiments, the cryptographic proof is a root hash of a Merkel tree that combines multiple hashes representative of a batch of multiple transactions. The blockchain account can maintain a Merkle Root and proof of inclusion, and the off-chain account can manage original transaction details and intermediate hashes for the Merkle tree proof of commitment scheme. In some embodiments, the cryptographic proof is a polynomial proof of commitment for recording an individual off-chain transaction.

In some embodiments, the off-chain account stores transaction details, details about a commitment scheme in relation to the cryptographic proof, the user's account details, and the user's personal identifiable information. The details about the commitment scheme includes one or more of polynomial coefficients or intermediate hashes.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows an exemplary diagram of a hybrid recordkeeping platform used in a computing environment for tracking a user's financial asset, according to some embodiments of the present invention.

FIG. 2 shows an exemplary process utilizing the hybrid recordkeeping platform of FIG. 1 to manage a user's financial asset, according to some embodiments of the present invention.

FIG. 3 shows an exemplary configuration of the blockchain account of a user as a part of the hybrid recordkeeping platform of FIG. 1, according to some embodiments of the present invention.

FIG. 4 shows an exemplary process executed by the smart contract of a user's blockchain account of FIG. 3 to process a transaction request, according to some embodiments of the present invention.

FIG. 5 shows an exemplary implementation of the transaction request execution process of FIG. 4 for executing a withdrawal request with respect to a target retirement plan, according to some embodiments of the present invention.

FIG. 6 shows an exemplary configuration of a transaction structure generated by the smart contract in association with the withdrawal request of FIG. 5, according to some embodiments of the present invention.

FIG. 7 shows an exemplary implementation of the transaction request execution process of FIG. 4 for executing a contribution request with respect to a target retirement plan, according to some embodiments of the present invention.

FIG. 8 show an exemplary configuration of a user's off-chain account within the hybrid recordkeeping platform of FIG. 1, according to some embodiments of the present invention.

FIG. 9 shows an exemplary process for enrolling a user to the hybrid recordkeeping platform of FIG. 1, according to some embodiments of the present invention.

### DETAILED DESCRIPTION

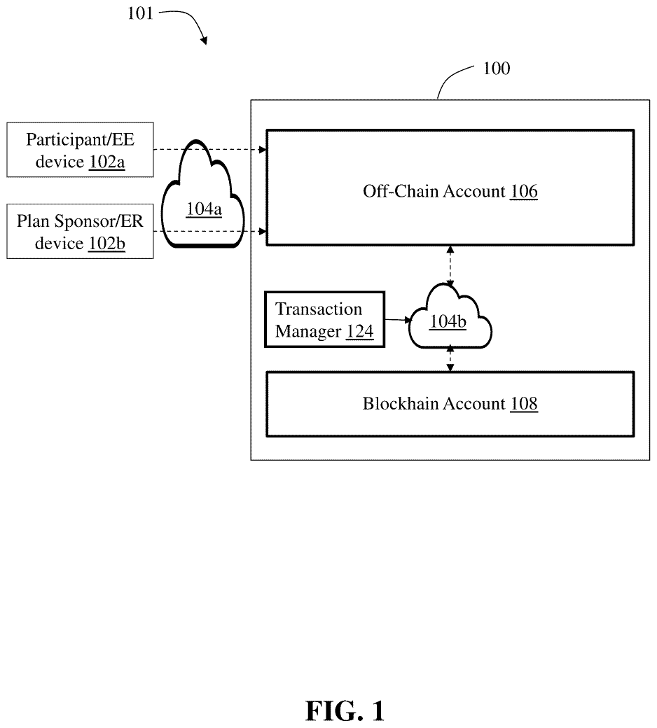

FIG. 1 shows an exemplary diagram of a hybrid recordkeeping platform 100 used in a computing environment 101 for tracking a user's financial asset, according to some embodiments of the present invention. As shown, computing environment 101 generally includes one or more client computing devices 102a, 102b (collectively referred to as 102), one or more communication networks 104a, 104b (collectively referred to as 104), and the hybrid recordkeeping platform 100 comprising an off-chain account 106 and a blockchain account 108 associated with the user, both of which are managed by the transaction manager 124 of the platform 100. Even though the platform 100 of FIG. 1 is described below in the context of managing a participant's retirement investments in one or more 401(k) plans, the platform 100 can be generalized to the management of any form of financial assets held by an individual.

The multiple client computing devices 102 can include (i) at least one computing device 102 a associated with the individual user who owns one mor more 401(k) plans and (ii) at least one computing device 102b associated with a plan sponsor representative of an organization or employer administering the 401(k) plans on behalf of the user. In some embodiments, the client computing devices 102 additionally include one or more devices (not shown) associated with a backend office responsible for administrative tasks related to plan management. In some embodiments, the client computing devices 102 additionally include one or more devices (not shown) associate with a corporate actor that monitors corporate events impacting investments. The client computing devices 102 can connect to the communication network 104 to interact with the hybrid recordkeeping platform 100 to provide inputs and receive outputs for user asset tracking and management. For example, the computing device 102a can display one or more detailed graphical user interfaces (GUI) that show transaction history and pertinent details in relation to the user's one or more 401(k) plans. Exemplary computing devices 102 include, but are not limited to, telephones, desktop computers, laptop computers, tablets, mobile devices, smartphones, and internet appliances. It should be appreciated that other types of computing devices that are capable of connecting to the components of the computing environment 101 can be used without departing from the scope of invention.

The communication networks 104 enable components of the computing environment 101 to communicate with each other to perform financial asset recordkeeping via the hybrid platform 100. Each network 104 may be a local network, such as a LAN, or a wide area network, such as the Internet and/or a cellular network. In some embodiments, each network 104 is comprised of several discrete networks and/or sub-networks (e.g., cellular to Internet) that enable the components of the computing environment 101 to communicate with each other.

The recordkeeping platform 100, which employs a hybrid architecture comprising the off-chain component 106 and the blockchain component 108, is a combination of hardware, including one or more processors and one or more physical memory modules and specialized software engines, to receive data from other components of the computing environment 101, transmit data to other components of the computing environment 101, and perform functions as described herein. In some embodiments, the on-chain account 108 of the user resides on a blockchain, which is well understood by a person of ordinary skill in the art as a digital database that records and stores data across a network of computers. More specifically, blockchain is a decentralized digital ledger that securely stores records across a network of computers also known as “nodes” in a way that is transparent, immutable, and resistant to tampering. Each “block” includes data, and blocks are linked in a chronological “chain.” Blockchain preserves data integrity and enables security through cryptographic hashing and consensus mechanisms. As shown in FIG. 1, the blockchain account 108 can use blockchain technology to provide real-time knowledge of the state of the user's retirement plans, track interactions, and effectively measure the flow of values in and out of the various user retirement plans. The off-chain component 106 can implement business logics that expose the platform's capabilities and handle complex operations. The off-chain component 106 can also provide API interfaces to allow the client computing devices 102 to interact with the platform 100 to request transactions as well as parse/filter transaction history. In some embodiments, the hybrid platform 100 includes the transaction manager 124 configured to set global parameters and rules (e.g., a list of allowed money types and yearly maximum contributions), coordinate data synchronization between off-chain and on-chain accounts 106, 108 in connection with the user, and perform other central management activities related to the entire platform 100. In some embodiments, the various components of the hybrid platform 100 are specialized sets of computer software instructions programmed onto a dedicated processor and can include specifically designated memory locations and/or registers for executing the specialized computer software instructions.

In general, the hybrid platform 100 of FIG. 1 combines off-chain and on-chain components 106, 108 to efficiently manage a user's investments and maintain accurate records. Such decoupling of the off-chain and on-chain components 106, 108 promotes flexibility and easy integration of new features. In addition, as explained in detail below, the platform 100 can maintain data integrity using a combination of on-chain succinct proof and off-chain additional proof and context with enhanced transparency. Furthermore, unique identifiers assigned by the platform 100 ensure seamless context management across different system layers.

In some embodiments, the hybrid recordkeeping platform 100 is built on the user's right-to-be-forgotten data protection compliance. A user-owned/controlled nonce (i.e., a random or semi-random number generated and/or managed by the user) is used to encrypt on-chain data anchors; the right-to-be-forgotten is achieved by deleting this nonce; a proof-of-deletion is submitted on-chain. In some embodiments, the hybrid recordkeeping platform 100 is event-based, driven by actions taken with respect to the enrolled user accounts, rather than process-oriented with scheduled batch reporting. As updates occur, they are visible in real-time (or near real time) to the affected user's off-chain account 106 and blockchain account 108.

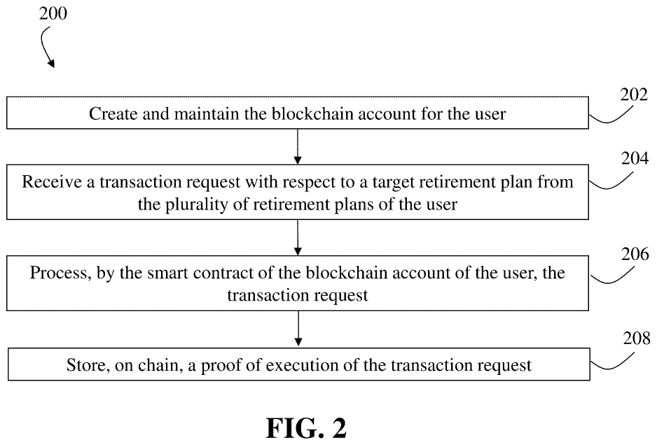

FIG. 2 shows an exemplary process 200 utilizing the hybrid recordkeeping platform 100 of FIG. 1 to manage a user's financial asset, according to some embodiments of the present invention. For example, process 200 can be configured to utilize the hybrid platform 100 to maintain/manage multiple retirement plans (e.g., 401(k) plans) for the user, where each plan is associate with a set of plan rules and an employer administering the plan. The user can interact with his or her plans via the client computing device 102a, such as executing contributions, withdrawals and/or fund elections. The multiple retirement plans can be sponsored by the user's employers who can interact with the platform 100 to, for example, register or deregister a retirement account in the user's name. These events can be processed by the platform 100 using a combination of the blockchain account 108 and off-chain account 106 associated with the user as coordinated by the transaction manager 124. In general, the hybrid platform 100 can process transactions (e.g., money-in, money-out, dividends and exchanges, etc.), administer plan rules, and track/manage contributions from various employers.

Process 200 starts at step 202 with the platform 100 creating and maintaining the off-chain account 106 and the blockchain account 108 for the user. In some embodiments, a pair of the off-chain and on-chain accounts 106, 108 are created by the transaction manager 124 for each user enrolled with the platform 100. In general, the user's retirement account is tokenized as non-fungible tokens (NFT) on the blockchain in the blockchain account 108, while the actual retirement account data stays off-chain in the off-chain account 106. This tokenization acts as a unique identifier for the account, guarantees on-chain ownership, and connects all associated data and metadata both on chain and off chain.

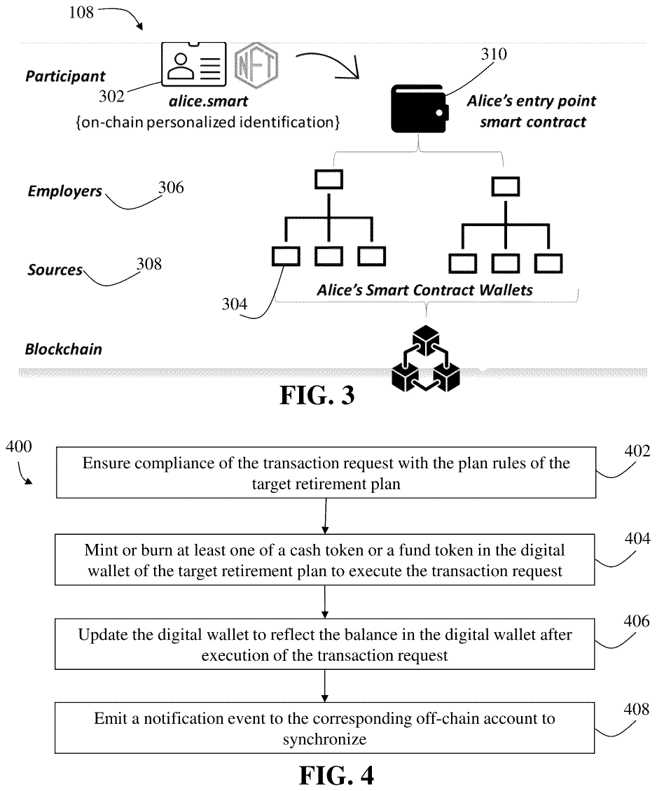

FIG. 3 shows an exemplary configuration of the blockchain account 108 of a user as a part of the hybrid recordkeeping platform 100 of FIG. 1, according to some embodiments of the present invention. As shown, the on-chain account 108 is assigned an on-chain identifier 302 that is cryptographically derived from the user's off-chain personal information stored in the corresponding off-chain account 106. Thus, the identifier 302 provides an on-chain mapping to the user's off-chain identity. Each personalized identifier 302 can be minted as a non-fungible token (NFT), which serves as a unique representation of the user's identity within the platform 100, guarantees on-chain ownership and connects data and metadata of all the user's retirement plans, including retirement account data in the user's off-chain account. In addition, the personalized NFT identifier 302 can record the user's consent for the portfolio management by the platform 100 regarding his/her various retirement plans in advance of any transaction execution. Therefore, the personalized NFT identifier 302 can provide auditable records and immutable proof of user agreement, as well as facilitate clear communication and document of intent prior to execution. Optionally, a user-controlled nonce can be used for the derivation of the on-chain identifier 302. In some embodiments, reverse engineering from the on-chain identifier 302 to the user's off-chain identity is impossible, thereby ensuring the user's anonymity. In some embodiments, the identifier 302 is provisioned and issued by the transaction manager 124 of the hybrid recordkeeping platform 100, which can maintain a registry of these identifiers 302 for all enrolled users.

The blockchain account 108 for each user can be broken down hierarchically into multiple layers comprising an employer layer 306 identifying the various employers administering retirement plans for the user and a source layer 308 identifying different types of the 401(k) plans administered by each employer, such as pretax, Roth, traditional, etc. A digital wallet 304 is created per employer, per account type. Each wallet 304 represents a virtual digital cryptocurrency storage of the user's retirement plan for the corresponding account type and employer. In some embodiments, each wallet 304 has a digital address (e.g., made up of alphanumeric characters) that is used to identify the wallet digitally. The digital identifier of each wallet 304 can be provisioned and issued by the transaction manager 124 of the hybrid recordkeeping platform 100, which can maintain a registry of these identities for all enrolled users. In some embodiment, the user's on-chain identifier 302 is stored in one or more of the digital wallets 304. Additionally, each digital wallet 304 is configured to store the current election of one or more funds associated with the corresponding retirement plan, one or more crypto tokens representative of fiat money available in the retirement plan, shares of the one or more funds in the retirement plan, along with individual and employer contributions for the retirement plan. Thus, employer contributions from different employers can be tracked and managed separately within a single user account.

In some embodiments, the user's blockchain account 108 also includes a smart contract 310 configured to automatically manage the digital wallets 304 in the user's on-chain account 108, execute transactions, ensure compliance with various rules corresponding to the retirement plans, and manage the individual and employer contributions to the retirement plans. As an example, for investment and liquidation transactions with respect to a user's retirement plans, the smart contract 310 generally uses two kinds of crypto tokens stored in the user's digital wallet(s) 304—cash tokens and fund tokens. A crypto token refers to (i) a fungible virtual currency that functions as a tradable asset, (ii) a utility that resides on a specific cryptocurrency's blockchain, or (iii) a non-fungible (non-tradable) unit of data used to validate an object as unique. Tokenization refers to the process of protecting sensitive data by replacing that data with algorithmically-generated unique identification symbols (in the form of tokens) that have no exploitable value. In the context of the present invention, cash tokens are entirely fungible and represent cash, such as in the form of fiat currency and/or stablecoins. Stablecoins are a type of cryptocurrency designed to maintain a stable value by being pegged to a reserve asset, such as a fiat currency (like the U.S. dollar) or a commodity (like gold). This stability makes stablecoins less volatile compared to other cryptocurrencies. Fund tokens are semi-fungible in that fund tokens of the same fund are fungible and fund tokens of different funds are non-fungible. Fund tokens can represent one or more of shares in a fund and/or tokenized asset classes (e.g., equity, mutual funds, bonds, etc.). In addition, fund holdings can be managed by the smart contract 310 at the plan-sponsor/employer level 306 and further granularity exists at the account type level 308. The smart contract 310 is configured to mirror off-chain investments and liquidation activities on chain with these cash tokens and fund tokens, as explained in detail below. Thus, the smart contract 310 can securely track the user's money movement and fund holdings, enabling real-time auditability and transparency.

The smart contract 310 can be programmatically coded into a blockchain network based on predefined terms. The smart contract 310 on the blockchain can automatically execute agreed transactions once compliance with plan rules is met. This replaces traditional models where manual processes, paperwork and other third parties are required to validate a transaction. In this context, the smart contract 310 is faster, more efficient, and more secure, with no need for intermediaries. In some embodiments, one instance of smart contract 310 is established per enrolled user of the platform 100. In some embodiments, the smart contract 310 can also store data such as per-year contribution totals, transaction requests that are awaiting pricing, and/or the digital addresses of the wallets 304 in the user's blockchain account 108.

Referring again to process 200 of FIG. 2, at step 204, the platform 100 can receive, via a digital graphical user interface (GUI) associated with the off-chain account 106 of the user, a transaction request from the user with respect to a particular retirement plan managed by the platform 100. The request can be, for example, one of withdrawal, contribution, exchange, dividend allocation, rollover or any corporate action that necessitates adjustment to the plan holdings. Since the request is made by the user via the off-chain component 106, the block-chain component 108 is not exposed to the user, and the user has no direct access to any on-chain asset. At step 206, the transaction manager 124 can coordinate forwarding of the transaction request from the off-chain account 106 to the on-chain account 108, at which the transaction request is processed by the smart contract 310 of the user's blockchain account 108. In some embodiments, the transaction request is digitally signed by the user's encryption key in a cryptographic encryption scheme prior to the smart contract 310 processing the transaction request to verify authenticity, integrity, and non-repudiation of the transaction request.

FIG. 4 shows an exemplary process 400 executed by the smart contract 310 of the user's blockchain account 108 of FIG. 3 to process a transaction request, according to some embodiments of the present invention. As shown, upon receiving a transaction request with respect to a target retirement plan, the smart contract 310 is adapted to first ensure compliance of the transaction request with the plan rules of the target retirement plan (step 402). If the transaction request is compliant with the plan rules, the smart contract 310 proceeds to manipulate the balance of crypto tokens in the digital wallet 304 of the target retirement plan to fulfill the transaction request (step 404). In general, a transaction request (e.g., contribution, withdrawal, exchange, or rollover etc.) is adapted to affect the balance of crypto tokens stored in the digital wallet 304 of the target retirement plan. For example, fulfilling a transaction request may involve minting or burning at least one of a cash token (including fiat currency and/or stablecoins) or a fund token (including fund shares and/or tokenized asset classes) in the digital wallet 304 of the target retirement plan. “Minting” refers to the process when a new token is created to represent an asset digitally on-chain. Once the token has been minted it can be added or removed to a digital wallet 304 to demonstrate the addition or removal of the asset value. “Burning” is when the represented value is no longer needed in a digital form and the token is “burned” for removal from a digital wallet 304. In some embodiments, such adjustment to the balance in the digital wallet 304 is executed without requiring a bank for fiat money transfer in the corresponding off-chain account 106. The digital wallet 304 is subsequently updated by the smart contract 310 to reflect token balance after execution of the transaction request (step 406). In addition, the smart contract 310 generates and emits a notification event to the corresponding off-chain account 106 to synchronize with the blockchain account 108 by honoring the transaction request (step 408).

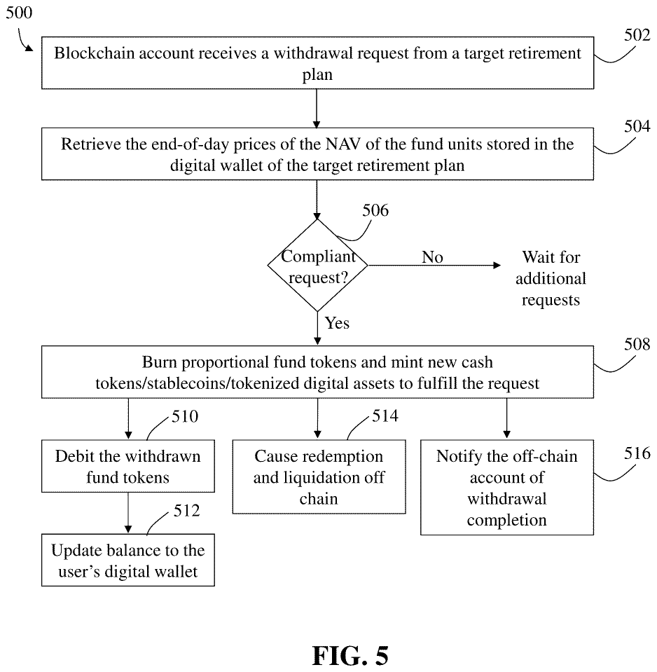

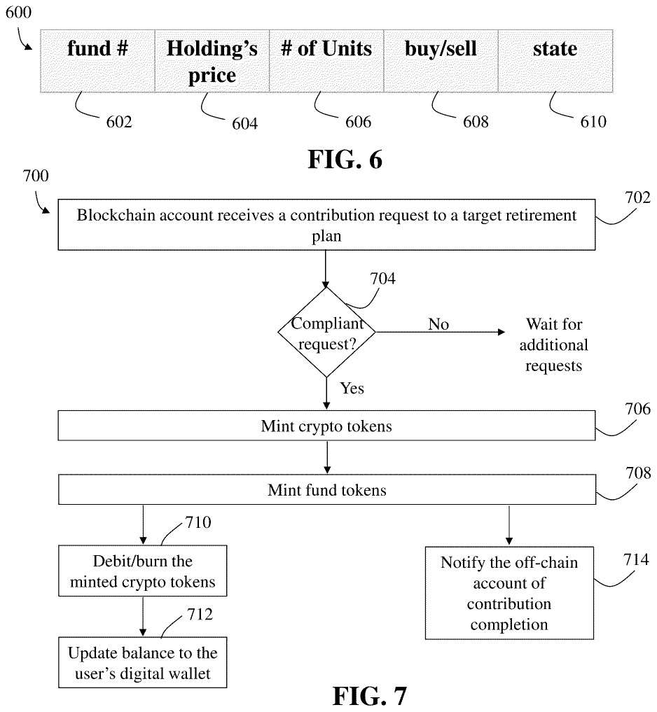

FIG. 5 shows an exemplary implementation 500 of the transaction request execution process 400 of FIG. 4 for executing a withdrawal request with respect to a target retirement plan, according to some embodiments of the present invention. The process starts with the user initiating a withdrawal request via the GUI of his/her off-chain account 106 (step 502), which is then forwarded to the user's blockchain account 108 by the transaction manger 124. Upon the blockchain account 108 of the user receiving the withdrawal request, the smart contract 310 of the blockchain account 108 is configured to ensure compliance of the request with the rules of the target retirement plan, including determining whether the withdrawal amount requested exceeds the balance held within the digital wallet 304 of the target retirement plan. When a hybrid platform is used, the balance is accomplished by first retrieving the end-of-day prices stored in the digital wallet 304 of the target retirement plan (step 504) and then checking whether the digital wallet 304 includes sufficient balances based on the end-of-day prices to fulfill the withdrawal request (step 506). If a hybrid platform is not being used, and the blockchain is the only source of record, pricing will be based on market price feeds via a blockchain oracle service. If there is sufficient fund, the withdrawal process proceeds; otherwise, the smart contract 310 terminates the withdrawal process and waits for a new request. Additional checks for ensuring compliance of the withdrawal request with plan rules (at step 506) involves the smart contract 310 applying withdrawal rules and considering calculations, withdrawal factors, fees, taxes, and other relevant factors. FIG. 6 shows an exemplary configuration of a transaction structure 600 generated by the smart contract 310 in association with the withdrawal request of FIG. 5, according to some embodiments of the present invention. As shown, the on-chain structure 600 can include a composite of information required to execute the withdrawal request, including the fund holding identifier from with withdrawal is requested 602, the end-of-day prices 604, the number of units of fund holding 606 currently in the digital wallet 304, the transaction intent 608 (e.g., the number of units intended to be redeemed in the withdrawal request), and the transaction state 610 (e.g., one of in-progress, settled or cancelled). Optionally, the transaction structure 600 may be encrypted, e.g., digitally signed using the user's encryption key, to demonstrate ownership and ensure non-repudiation of origin. For example, a cryptographic algorithm can be used to generate a unique digital signature based on the transaction data and the signer's private key. The recipient verifies this digital signature using the signer's public key. A valid signature confirms that the transaction originated from the rightful owner without modification.

Referring back to FIG. 5, if the withdrawal request is compliant, the smart contract 310 proceeds to burn proportionate existing fund tokens in the digital wallet 304 and mint new cash tokens (e.g., fiat currency and/or stablecoins) or tokenized digital assets to execute the withdrawal request (step 508). Specifically, this can be accomplished by burning a certain amount of existing fund tokens from the digital wallet 304 of the target retirement plan, where the amount is equivalent to the withdrawal amount requested. If the withdrawal request is in fiat currency, the smart contract 310 proceeds to mint an equivalent amount of either (i) cash tokens (e.g., fiat currency and/or stablecoins) for addition to the digital wallet 304 or (ii) tokenized digital assets for addition to the digital wallet 304. After the execution of the withdrawal request, the smart contract 310 debits the withdrawn fund tokens from the digital wallet 304 (step 510) and updates the token balance in the digital wallet 304 to reflect the burnt fund tokens and newly minted cash token or tokenized digital assets (step 512). In some embodiments, the transaction structure 600 generated by smart contract 310 is updated at every step to reflect the current status of the transaction. For example, the state 610 of the transaction structure 600 can be set to “in progress” during the minting and burning steps.

The smart contract 310 can further emit an event to the user's off-chain account 106 to notify the off-chain account 106 to honor/redeem the withdrawal request, liquidate fund holdings, and settle the trade out-of-platform (step 514). More specifically, the transaction manger 124 of the hybrid recordkeeping platform 100 can forward the event notification from the smart contract 310 to an off-chain redeem service module (not shown) to redeem the withdrawn request and settle the transaction. For example, the event notification can specify information related to the withdrawal transaction, including the fund affected, and the redemption amount. The redeem service can process this by invoking an external trade system for liquidation. The redeem service module can await acknowledgement from the external trade system before crediting the fiat amount to the user's bank account. In some embodiments, if newly minted tokens are stablecoins or tokenized digital assets, they can be redeemed through the redeem service module for fiat currency directly through decentralized exchanges or over-the-counter markets, eliminating the need for wire transfers. Upon successful trade settlement (i.e., when the fiat amount is credited to the user's bank account), the user's off-chain account 106 can notify the blockchain account 108 accordingly, in which case an equivalent amount of cash token is burnt by the smart contract 310 to reflect the money transfer to the user and the user's balance in the digital wallet 304 is updated accordingly. Finally, the smart contract 310 can send a blockchain event to the off-chain account 106 to notify the off-chain account and/or external systems that the withdrawal request is completed (step 516). The smart contract 310 can also update the transaction structure 600 accordingly, such as changing the state 610 of the transaction structure 600 to “settled” to mark the completion of the trade.

As another example, the transaction request execution process 400 of FIG. 4 can be adapted to execute a contribution request from the user. FIG. 7 shows an exemplary implementation 700 of the transaction request execution process 400 of FIG. 4 for executing a contribution request with respect to a target retirement plan, according to some embodiments of the present invention. The process starts with the user initiating a contribution request via the GUI of his/her off-chain account 106, which is then forwarded to the user's blockchain account 108 by the transaction manger 124 (step 702). The request can include an amount to contribute and the specific fund(s) of the target retirement plan to which contribution is made. Upon the blockchain account 108 of the user receiving the contribution request, the smart contract 310 ensures compliance of the request with the rules of the target retirement plan (step 704), including applying pre-stored rules and considering calculations, contribution factors, fees, taxes, and other relevant factors. In some embodiments, the smart contract 310 is adapted to generate a transaction structure, such as the structure 600 of FIG. 6, to represent the contribution request.

If the contribution request is compliant, the smart contract 310 proceeds to mint a certain amount of crypto assets, including cash tokens (e.g., fiat currency and/or stablecoins) and/or tokenized digital assets for addition to the digital wallet 304 of the target retirement plan (step 706), where the amount is equivalent to the contribution amount requested. This indicates that the contribution money has moved into the blockchain account 108. Thereafter, the smart contract 310 is adapted to mint an equivalent amount of fund tokens (e.g., at the end-of-the-day fund prices) for addition to the same digital wallet 304 (step 708). The smart contract 310 can debit/burn from the digital wallet 304 the newly minted crypto assets from step 706 to represent the purchase of the funds (step 710). The smart contract 310 can then update the crypto token balance in the digital wallet 304 to reflect the minted fund tokens from the contribution request (step 712). The smart contract 310 can further emit an event to the user's off-chain account 106 to notify the off-chain account 106 to honor the contribution request (step 714). For example, the transaction can be submitted to the external redeem service module for investing into the desired fund of the target retirement plan.

As yet another example, the transaction request execution process 400 of FIG. 4 can be adapted to execute an exchange request with respect to an originating fund and a desired fund in a target retirement plan associated with the user. In an exchange transaction, the user's smart contract 310 of the blockchain account 108 is configured to generate a transaction structure, such as the structure 600 of FIG. 6, to represent the exchange request. The smart contract 310 first burns the requested amount of fund tokens of the originating fund as specified by the exchange request. The smart contract 310 then mints an equivalent amount of cash tokens (e.g., fiat current and/or stablecoins). The smart contract 310 subsequently mints an equivalent amount of fund tokens of the desired fund and burns the minted cash tokens that are used to purchase the desired fund. The smart contract 310 can also update the user's wallet balance to reflect the exchanged tokens as well as send notifications to the user's off-chain account 106 to synchronize data and actions off-chain. In addition, the smart contract 310 can update the transaction status 610 in the transaction structure 600 of the exchange request throughout the fulfillment process.

As yet another example, the transaction request execution process 400 of FIG. 4 can be adapted to execute a corporate action/request that requires adjustment to one or more holdings in a target retirement plan. Such a corporate action can be any type of that derives from an originating fund and resulting in a target fund within the target retirement plan and/or a cash allocation that is reinvested into one or more target funds within the target retirement plan. In this type of transaction, the user's smarter contract 310 of the blockchain account 108 is configured to generate a transaction structure, such as the structure 600 of FIG. 6, to represent the request. The smart contract 310 first burns a specific amount of fund tokens from the originating fund in the digital wallet 304 associated with the target retirement plan. The smart contract 310 then mints an equivalent amount of crypto asset comprising at least one of cash tokens, stablecoins or tokenized digital assets, followed by minting an equivalent amount of fund tokens for addition into the target fund in the digital wallet 304 while burning the previously minted crypto asset. The smart contract 310 then updates the balance in the digital wallet 304 of the user to reflect the exchange in fund tokens between the originating fund and the target fund.

Referring back to FIG. 2, after the smart contract 310 of the user's blockchain account 108 processes the user-initiated transaction request, the smart contract 310 is configured to save on chain a cryptographic proof of execution of the completed transaction request (step 208). The cryptographic proof is a concise representation of a transaction's inclusion within a specific block of the blockchain. It enables verification of a transaction's existence (including the existence of corresponding off-chain data related to the transaction) without requiring the entire block's data, thereby enhancing data integrity without overburdening storage capacity. A cryptographic proof can be generated using one of multiple commitment schemes, including a hashed proof-of-commitment for generating an on-chain proof that records an individual transaction, a Merkel tree commitment scheme in which a root hash that combines multiple hashes (representative of a batch of multiple transactions) is stored on chain, and a polynomial proof-of-commitment for generating an on-chain proof that records an individual transaction. Details of each one of these commitment schemes are provided below. In general, a cryptographic proof generated using any one of these commitment schemes can include a transaction identifier, succinct details about the transaction, a timestamp of the execution of the transaction, and other relevant metadata. The transaction details in the cryptographic proof can include identification of parties involved, amounts, and types of assets, etc., similar to the data in the transaction structure 600 of the transaction request. The timestamp can record the creation time of the off-chain data related to the transaction. This establishes a verifiable reference point for data age and authenticity and helps to prevent data manipulation after a specific point in time. In some embodiments, if a Merkle tree commitment scheme is used to generate the cryptographic proof for a transaction, data included in the proof can also specify the path of the hash for the transaction within a Merkle tree, including hashes of one or more sibling nodes. In some embodiments, the cryptographic proof is digitally signed. The cryptographic proof can be stored on chain in the user's blockchain account or in a separate on-chain account dedicated to storing transaction proofs.

In addition to managing proof data on the blockchain, proof data can also be managed off-chain in the user's off-chain account 106, depending on the commitment schemes used. On-chain data typically includes only the essential information needed to ensure security, transparency, and verifiability, such as commitment hashes, Merkle roots, and evaluation proofs. Conversely, off-chain storage holds most of the data, including original values, transaction details, polynomial coefficients (e.g., for a polynomial proof of commitment), intermediate hashes (e.g., for a Merkel tree proof of commitment), and individual off-chain recordkeeper account details and personal identifiable information, to optimize storage costs and maintain privacy.

In an exemplary implementation of managing proof data using the hashed proof of commitment scheme, a user's blockchain account 108 can maintain the commitment hash and revealed value for a particular transaction (e.g., withdrawal, contribution, exchange, etc.), while the off-chain account 106 can manage the original transaction data for that transaction. Any change in the off-chain data is adapted to alter the hash, thereby alerting the user to potential data tampering. The hash of the committed transaction data is stored on-chain, ensuring that the commitment is immutable and publicly verifiable. When the commitment is revealed, the original transaction data and the hash function used are provided on-chain to verify the commitment. The actual transaction details (e.g., amounts, sender, receiver) are kept off-chain until they need to be revealed.

In an exemplary implementation of managing proof data using the Merkle Tree proof of commitment scheme, the blockchain account 108 can maintain a root hash of the Merkle Tree to provide a concise representation of data for a batch of multiple transactions, while the off-chain account 106 manages (i) the original transaction data for the individual transactions in the batch and (ii) intermediate hashes of the individual transactions generated for the Merkle Tree representation. In general, a Merkel tree is a way of combining multiple hashes into a single root hash, which can represent a collection of data associated with multiple transactions or a series of updates. By storing the hashes or the root hashes on the blockchain, a user can validate the original data or track its changes over time. In addition, using the Merkel tree root to anchor off-chain data to the blockchain can save space because only the Merkel tree root, which represents a large amount of data points, is stored on-chain instead of the data itself. Thus, the root hash of the Merkle Tree can serve as a data anchor for a batch of transactions and provide efficient and secure verification of the individual transactions in the batch. When verifying a specific transaction, the intermediate hashes are provided on-chain to reconstruct the path to the root. The actual transaction details (e.g., amounts, sender, receiver) are kept off-chain until they need to be revealed. The intermediate hashes used in the Merkle proof are also kept off-chain until needed for verification. In some embodiments, the Merkle Tree proof of commitment scheme is employed for extensive datasets, while for smaller datasets, the hashed proof of commitment or polynomial proof of commitment is used for recording individual data points.

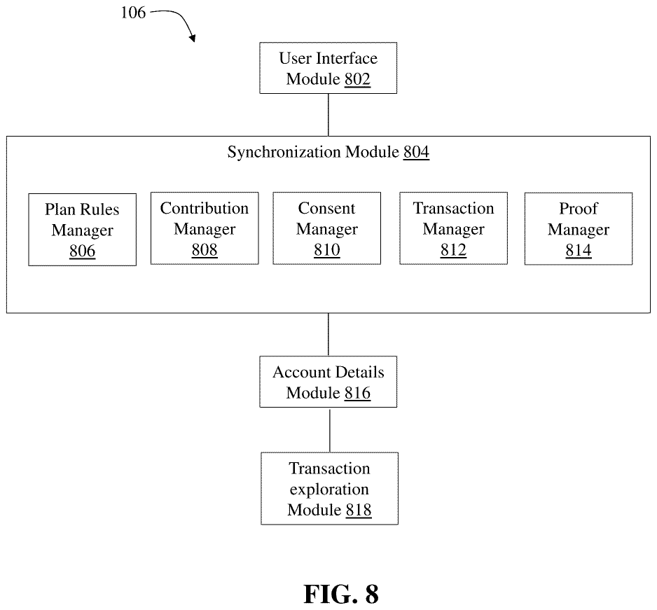

FIG. 8 show an exemplary configuration of a user's off-chain account 106 within the hybrid recordkeeping platform 100 of FIG. 1, according to some embodiments of the present invention. As shown, the off-chain account 106 includes a user interface module 802 for allowing the user to interact with the hybrid platform 100 by initiating, editing, and/or viewing transactions and retirement plan details. The off-chain account 106 also includes a synchronization module 804 that serves as a portal to the on-chain account 108 and is configured to manage and synchronize data between the two accounts. For example, the synchronization module 804 can manage user interactions, transaction logics and proof of commitment logic between the two accounts. As shown, the synchronization module 804 includes a plan rules manager 806 for verifying off-chain contribution eligibility against plan rules, a contribution manager 808 for processing contribution logic and updating the user account off-chain, and a consent manager 810 for managing user confirmations/consents regarding contributions and transactions via the user interface module 802. The synchronization module 804 can also include a transaction manager 812 that handles individual transaction processing and recordkeeping as well as a cryptographic proof manager 814 that groups transactions into batches if the Merkle tree proof-of-commitment is employed and calculates cryptographic proofs (e.g. hashes or polynomials) for transactions and updates. In some embodiments, the off-chain account 106 includes an account details module 816 that maintains user information and enrollment data and reflects contribution updates. In some embodiments, the off-chain account 106 can provide a transaction exploration module 818 configured to store detailed original transaction logs for auditing and exploration purposes. For example, via the user interface module 802, the user can parse and filter the transaction logs to obtain a comprehensive view of their transaction history, including detailed information about each transaction (e.g., date, time, amount, and type), specific transactions, or transactions over a desired time period. The transaction exploration module 818 can also provide visualization tools to help users understand their investment performance over time.

In some embodiments, a user's off-chain account 106 is configured to store different types of data associated with retirement plan recordkeeping, such as data of the various retirement plans (e.g., plan identifications and employer identifications, etc.), user information (legal name, social security number, contribution percentages, etc.), and platform enrollment data (platform username, blockchain signing key, etc.). The off-chain account 106 can also store information for mapping to the user's on-chain account 108. Furthermore, the off-chain account 106 can include original details of historical and ongoing transactions in relation to the various retirement plans that map to the on-chain transactions described above.

In fact, storage of different types of data associated with a user's retirement plans can be distributed, managed and synchronized between the user's off-chain account 106 and blockchain account 108 within the hybrid platform 100. In an exemplary scheme for storing data related the various retirement plans of a user within the hybrid platform 100, certain retirement plan data is converted into digital tokens and stored in the user's blockchain account 108 for efficient management and tracking. The digital tokens can include tokenized plan identifications, shares, voting rights and unique token (e.g., NFTs), while the user's off-chain account 106 can provide actual plan data storage, compliance checks, and reporting tools, including, for example, storing plan documents, investment options and administration rules. In general, the on-chain tokens associated with the retirement plans represent plan ownership and transaction history, while the off-chain account manages detailed plan data and compliance. To map the on-chain tokens to the off-chain plan data, off-chain plan documents can reference the on-chain plan ID for verification. Voting rights can be exercised on-chain, and off-chain data determines voting power based on token holdings.

In an exemplary scheme for storing personal data for the user within the hybrid platform 100, certain user data is converted into digital tokens and stored in the user's blockchain account 108. The digital tokens, which represent individual participant identities and entitlements within the retirement plans, include tokenized user identification, encrypted personal information, tokenized account balance and identity token. The user's off-chain account 106 can provide actual personal data storage and authentication, including storing the full name of the user, contact information, investment preferences, and contribution history, for example. In general, the on-chain tokens associated with the user data ensure secure participant identity and entitlement tracking, while the off-chain account manages personal data and authentication, To map the on-chain tokens to the off-chain user data, the user identification links the blockchain account to the off-chain participant data, while on-chain encrypted personal information allows for basic identity verification and off-chain data is used for account management and communication.

In an exemplary scheme for storing data related to the user's account in the hybrid platform 100, certain account data is converted into digital tokens and stored in the user's blockchain account 108. The digital account tokens, which represent account ownership and transaction history within the account, include tokenized account identification, tokenized balance, investment allocation, and unique tokens in the form NFTs. The user's off-chain account 106 can provide actual account data storage, transaction processing, and user interfaces, including storing transaction history details, tax information and investment details, for example. In general, the on-chain tokens associated with the account data track account ownership and transactions, while the off-chain account manages detailed account data and interactions. To map the on-chain tokens to the off-chain account data, the account identification links the on-chain balance to the off-chain account data, and the detailed transaction history is stored off-chain for recordkeeping.

In an exemplary scheme for storing user consent data in the hybrid platform 100, certain consent data is converted into digital tokens and stored in the user's blockchain account 108. The digital tokens, which represent tokenized approvals for user consent to data sharing and transactions, include tokenized consent identification, action type (e.g., contribution, withdrawal, exchange, etc.), expiration time and unique tokens in the form NFTs, for example. The user's off-chain account 106 can provide consent management and communication tools, including storing consent details and reason for consent, for example. In general, the on-chain tokens associated with the user consent data track consent approvals, while the off-chain account handles consent management and participant interactions. To map the on-chain tokens to the off-chain consent data, the consent identification references the specific action on-chain and the off-chain details provide context for the consent.

In an exemplary scheme for storing investment fund data within the hybrid platform 100, certain fund data is converted into digital tokens and stored in the user's blockchain account 108. The digital tokens, which represent tokenized investment funds and allocations within retirement plans, include tokenized fund identifications, shares, performance data (hashed), and fungible tokens, for example. The user's off-chain account 106 can provide storage of actual fund performance data, risk analysis tools, and compliance checks, including storing full fund information, investment strategies and prospectus, for example. To map the on-chain tokens to the off-chain fund data, the fund identifications link on-chain data to the off-chain fund details and the hashed performance data allows for on-chain verification without compromising sensitive information.

In an exemplary scheme for storing transaction data in the hybrid platform 100, the user's off-chain account 106 can store original detailed transaction logs, audit trails, and transaction processing details for historical and/or ongoing transaction. The off-chain transaction data are batched and hashed together, where the resulting cryptographic hashes are stored in the user's blockchain account 108. In this storage scheme, the on-chain hashes ensure transaction integrity and immutability, where each hash serves as proof of the entire batch's existence and immutability, while the off-chain logs provide transaction records and processing capabilities for detailed recordkeeping. To map the on-chain transaction data to the off-chain transaction data, auditors can verify the batch hash on-chain for transaction integrity before referring to the off-chain logs for specific details of each transaction within the verified batch.

In an exemplary scheme for storing data related to a contribution request in the hybrid platform 100, the user's off-chain account 106 is configured to process payments, validate contributions, provide user interfaces for communication purposes, and store data including the original contribution request, user identification, investment factors, target plan details, amount to contribute in fiat current, and end-of-day pricing of the desired funds to purchase, for example. The blockchain account 108 can be used to track the contribution request fulfillment process, including storing the transaction identification, user identification, plan identification, number of fund units, crypto currency (e.g., cash tokens) minted for the representation of money contributed, crypto currency (e.g., fund tokens) minted for the purchase of the desired fund, crypto currency (e.g., cash tokens) burnt to purchase the equivalent amount of fund tokens in this trade. In general, the on-chain account 108 handles contribution records and facilitates participant contributions to retirement plans through tokenized transactions, while the off-chain account 106 processes payments and validates contributions.

In an exemplary scheme for storing data related to a withdrawal request in the hybrid platform 100, the user's off-chain account 106 is configured to process the withdrawal, report taxes, provide user interfaces for communication purposes, and store data including the original withdrawal request, user identification, withdrawal factors, target plan details, amount to withdraw in fiat current, and end-of-day pricing of the desired funds to withdraw from, for example. The blockchain account 108 can be used to track the withdrawal request fulfillment process, including storing the transaction identification, user identification, fund identification, number of fund units, crypto currency (e.g., fund tokens) burnt on fund liquidation, crypto currency (e.g., cash tokens) minted in equivalent amount of fund token value after the trade, representative of the amount wire transferred to the user's bank account. In general, the chain account 108 manages withdrawal records and transaction logs and enables users to withdraw funds from their retirement accounts using tokenized processes, while the off-chain account 106 handles processing and reporting.

In an exemplary scheme for storing data related to an exchange request in the hybrid platform 100, the user's on-chain account 108 is configured to execute exchange of assets via tokenized transactions, while the user's off-chain account 106 provides exchange rates and compliance monitoring. In an exemplary scheme for storing data related to dividend distribution in the hybrid platform 100, the user's on-chain account 108 is configured to handle distribution processing and records by distributing dividends to the user via tokenized payouts, while the user's off-chain account 106 calculates and processes dividends. In an exemplary scheme for storing data related to holdings tracking in the hybrid platform 100, the user's on-chain account 108 is configured to track the user's holdings in tokenized format for real-time portfolio management, while the user's off-chain account 106 analyzes performance and provide detailed reports. In an exemplary scheme for storing data related to positions tracking, the user's on-chain account 108 is configured to manage and monitor the user's positions in various investments via tokenized records, while the user's off-chain account 106 performs investment analytics, risk management and detailed reporting.

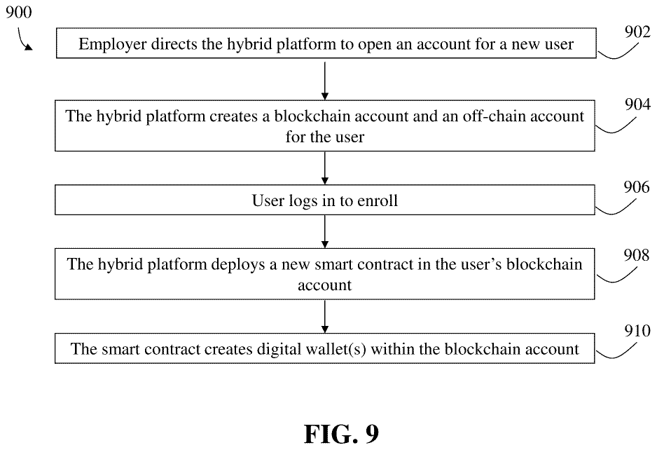

The hybrid platform 100 described above with reference to FIGS. 1-8 can be used to perform a variety of retirement account recordkeeping functions for an enrolled user, such as contribution, withdrawal and exchange transactions described with above reference to FIGS. 4-7. FIG. 9 shows an exemplary process for enrolling a user to the hybrid recordkeeping platform 100, according to some embodiments of the present invention. To start the process, an employer of the user can direct the platform 100 to open an account for a new user (step 902), where the new user can be a new participant of a retirement plan sponsored by the employer. Upon receiving the instructions, the platform 100 creates a set of an off-chain account 106 and a corresponding blockchain account 108 for the user (step 904). The user can then log into the off-chain account 106 to enroll, from which the user is assigned a blockchain identity that is linked to the user's blockchain account 108 (step 906). Upon linkage, the transaction manager 124 deploys a new smart contract 310 in the user's blockchain account 108 that may include default investment elections and balances (step 908). The smart contract 310 can then create one or more distinct digital wallets 304 within the blockchain account 108 for different account types of the user's retirement plans (step 910). Thereafter, the user may make investment elections and other transactions by interacting with the user interface via the off-chain account 106, which triggers certain blockchain activities as described above.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile computing device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile computing device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

1. A computerized method for maintaining a plurality of retirement plans for a user using a combination of a blockchain account and an off-chain account associated with the user, the plurality of retirement plans being sponsored by a plurality of employers of the user and associated with corresponding plan rules, the method comprising:
creating and maintaining the blockchain account for the user, the blockchain account comprising (i) one or more digital wallets corresponding to one or more retirement account types of the retirement plans sponsored by the employers, each digital wallet storing current election of one or more funds along with one or more crypto tokens representative of fiat money, shares of the one or more funds and individual and employer contributions; and (ii) a smart contract configured to manage the one or more digital wallets, the corresponding plan rules and the individual and employer contributions;
receiving, via a digital user interface associated with the off-chain account of the user, a transaction request with respect to a target retirement plan from the plurality of retirement plans;
processing, by the smart contract of the blockchain account of the user, the transaction request including:
ensuring compliance of the transaction request with the plan rules associated with the target retirement plan;
minting or burning at least one of a cash token or a fund token in relation to the one or more crypto tokens in the digital wallet associated with the target retirement plan to execute the transaction request without requiring a bank for fiat money transfer;
updating the digital wallet associated with the target retirement plan to reflect a balance in the digital wallet after execution of the transaction request; and
emitting a notification event to the corresponding off-chain account to synchronize with the blockchain account by honoring the transaction request; and
maintaining, by a synchronization module, data integrity and data security of the processed transaction request by:
updating the user's off-chain account to include transaction data that honors the transaction request upon receiving the notification event from the blockchain account;
creating a cryptographic proof comprising a root hash of a Merkel tree that combines multiple hashes representative of a batch of multiple transactions, including a hash of the transaction data for the processed transaction request;
storing, on chain in the user's blockchain account, the root hash;
storing, off chain in the user's off-chain account, the hash corresponding to the processed transaction request along with the transaction data; and
verifying the processed transaction by providing the hash from the user's off-chain account to the user's on-chain account to reconstruct a path to the root hash.

2. The method of claim 1, wherein the blockchain account of the user further includes an on-chain identification of the user cryptographically calculated from the user's personal information stored in the corresponding off-chain account.

3. The method of claim 1, wherein the blockchain account of the user includes a non-fungible token (NFT) uniquely identifies the user, guarantees on-chain ownership and connects associated data and metadata of the plurality of retirement accounts, including retirement account data in the user's off-chain account.

4. The method of claim 1, wherein the different retirement account types comprise different types of 401(k) plans, Roth plans, or after-tax plans.

5. The method of claim 1, wherein the at least one cash token is representative of one or more of fiat currency and stablecoins held within a digital wallet of the user, and wherein the at least one cash token is fungible.

6. The method of claim 1, wherein the at least one fund token is representative of one or more of shares in a fund and tokenized asset classes held within a digital wallet of the user, and wherein the at least one fund token is semi-fungible in that fund tokens of the same fund are fungible and fund tokens of different funds are non-fungible.

7. The method of claim 1, wherein minting at least one of a cash token or a fund token comprises adding a new token to the blockchain account, and wherein burning at least one of a cash token or a fund token comprises removing an existing token from the blockchain.

8. The method of claim 1, wherein the transaction request comprises one of contribution, withdrawal, exchange dividend allocation, rollover or a corporate action that necessitates adjustment to one or more holdings with respect to the target retirement plan.

9. The method of claim 1, wherein the transaction request comprises a contribution request to the target retirement plan and processing the contribution request by the smart contract comprises:
determining an amount of fiat currency for contribution to the target retirement plan;
minting an equivalent amount of crypto assets comprising at least one of cash tokens, stablecoins or tokenized digital assets for addition to the digital wallet associated with the target retirement plan;
minting an equivalent amount of fund tokens for addition to the digital wallet while burning the minted crypto assets from the digital wallet;
updating the digital wallet balance to reflect the minted fund tokens from the contribution.

10. The method of claim 1, wherein the transaction request comprises a withdrawal request from the target retirement plan and processing the withdrawal request by the smart contract comprises:
burning an equivalent amount of fund tokens from the digital wallet associated with the target retirement plan;
if the withdrawal request is in fiat currency, minting an equivalent amount of: (i) cash tokens for addition to the digital wallet and wire transferring an equivalent fiat amount to a bank account of the user, or (ii) stablecoins or tokenized digital assets for addition to the digital wallet without wire transferring to a bank account of the user; and
updating the digital wallet balance to reflect the burnt fund tokens and minted cash tokens, stablecoins or tokenized digital assets for the withdrawal.

11. The method of claim 1, wherein the transaction request comprises an exchange request from an originating fund to a target fund within the target retirement plan and processing the exchange request by the smart contract comprises:
burning a specific amount of fund tokens from the originating fund in the digital wallet associated with the target retirement plan;
minting an equivalent amount of crypto asset comprising at least one of cash tokens, stablecoins or tokenized digital assets;
minting an equivalent amount of fund tokens for addition into the target fund in the digital wallet while burning the minted crypto asset; and
updating the balance in the digital wallet of the user to reflect the exchange in fund tokens between the originating fund and the target fund.

12. The method of claim 1, further comprising digitally signing the transaction request prior to processing the transaction request by the smart contract to verify authenticity, integrity, and non-repudiation of the transaction request.

13. The method of claim 1, wherein the cryptographic proof further includes a hashed-proof-of-commitment for recording an individual off-chain transaction.

14. (canceled)

15. The method of claim 1, wherein the cryptographic proof further includes a polynomial proof of commitment for recording an individual off-chain transaction.

16. The method of claim 1, further comprising digitally signing the proof of execution of the transaction request.

17. The method of claim 1, further comprising storing a proof of execution in the user's off-chain accounting that includes a transaction identifier, information about the transaction request, information about the cryptographic proof, and a timestamp of the execution of the transaction request.

18. The method of claim 17, wherein the information about the cryptographic proof comprises a path of a cryptographic hash within a Merkle tree, including hashes of one or more sibling nodes.

19. The method of claim 17, further comprising storing the root hash of the Merkel tree of the cryptographic proof on chain in a separate on-chain account dedicated to storing transaction proofs.

20. The method of claim 1, further comprising storing, in the off-chain account, transaction details, details about a commitment scheme in relation to the cryptographic proof, the user's account details, and the user's personal identifiable information, wherein the details about the commitment scheme includes one or more of polynomial coefficients or intermediate hashes.

21. The method of claim 13, wherein the blockchain account maintains a commitment hash and revealed value, and the off-chain account manages original transaction details for the hashed-proof-of-commitment scheme.

22-24. (canceled)
